(19) United States
(12) Patent Application Publication
(10) Pub. No.: US 2026/0333329 A1
(43) Pub. Date: Oct. 22, 2026

(54) WAVEFORM DETERMINATION METHOD AND APPARATUS

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(21) Appl. No.: 19/476,630

(22) PCT Filed: Apr. 21, 2023
(86) PCT No.: PCT/CN2023/089942

§ 371 Date: Oct. 17, 2025

(51) Int. Cl. H04W 72/0453

(52) U.S. Cl. CPC H04W 72/0453

(57) ABSTRACT

A waveform determination method, performed by a terminal, includes: receiving waveform indication information sent by a network device; and determining working waveform information to be used by the terminal according to the waveform indication information. A waveform determination method, performed by a network device, includes sending waveform indication information to a terminal, wherein the waveform indication information is used for determining working waveform information to be used by a terminal.

### CROSS-REFERENCE TO RELATED APPLICATION

This application is a U.S. National Phase application of the International Patent Application No. PCT/CN2023/089942, filed Apr. 21, 2023, the entire contents of which are incorporated herein by reference.

### FIELD

The present disclosure relates to the field of wireless communication technology, and more particularly to a waveform determination method and apparatus.

### BACKGROUND

In a wireless communication network, there are multiple types of transmission waveforms. As a channel condition and a terminal service type change, a transmission waveform corresponding to a transmission channel should also be changed accordingly to adapt to the changes in channel and service type.

### SUMMARY

Embodiments of a first aspect of the present disclosure provide a waveform determination method, which is performed by a terminal and includes: receiving waveform indication information sent by a network device; and determining working waveform information to be used by the terminal according to the waveform indication information.

Embodiments of a second aspect of the present disclosure provide a waveform determination method, which is performed by a network device and includes: sending waveform indication information to a terminal, where the waveform indication information is used for determining working waveform information to be used by a terminal.

Embodiments of the present disclosure provide a communication device, which includes: a transceiver; a memory; and a processor. The processor is connected to the transceiver and the memory respectively, and configured to implement the method as described in embodiments of the first aspect or the method as described in embodiments of the second aspect.

Additional aspects and advantages of embodiments of present disclosure will be given in part in the following descriptions, become apparent in part from the following descriptions, or be learned from the practice of the embodiments of the present disclosure.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a schematic diagram showing an architecture of a communication processing system according to embodiments of the present disclosure;

FIG. 2 is a schematic flow chart of a waveform determination method applied to a communication system according to embodiments of the present disclosure;

FIG. 3 is a schematic flow chart of a waveform determination method applied to a terminal according to embodiments of the present disclosure;

FIG. 4 is a schematic flow chart of a waveform determination method according to embodiments of the present disclosure;

FIG. 5 is a schematic flow chart of a waveform determination method applied to a network device according to embodiments of the present disclosure;

FIG. 6 is a schematic timing diagram of a waveform determination method according to embodiments of the present disclosure;

FIG. 7 is a schematic block diagram of a waveform determination apparatus according to embodiments of the present disclosure;

FIG. 8 is a schematic block diagram of a waveform determination apparatus according to embodiments of the present disclosure;

FIG. 9 is a schematic structural diagram of a communication device according to embodiments of the present disclosure; and

FIG. 10 is a schematic structural diagram of a chip according to embodiments of the present disclosure.

### DETAILED DESCRIPTION

Embodiments of the present disclosure will be described in detail below, examples of which are illustrated in the accompanying drawings. The same or similar elements and the elements having same or similar functions are denoted by like reference numerals throughout the descriptions. Embodiments described below with reference to the accompanying drawings are illustrative and are intended to explain the present disclosure, and should not be construed as limitative on the present disclosure. It should be noted that embodiments of the present disclosure and their features may be combined with each other without conflict.

Embodiments of the present disclosure provide a waveform determination method. In some embodiments, terms like “waveform determination method”, “information processing method”, and “communication method” are interchangeable, terms like “waveform determination apparatus”, “information processing apparatus”, and “communication apparatus” are interchangeable, and terms like “waveform determination system”, “information processing system”, and “communication system” are interchangeable.

Embodiments of the present disclosure are not exhaustive, but are examples of some embodiments, and are not intended to constitute a limitation on the scope of protection of the present disclosure. In the absence of contradiction, each step in a certain embodiment may be implemented as an independent embodiment, and various steps may be arbitrarily combined. For example, a solution obtained after removing one or more steps from a certain embodiment may also be implemented as an independent embodiment, and steps in a certain embodiment may be arbitrarily exchanged in order. In addition, optional implementations in a certain embodiment may be arbitrarily combined. In addition, various embodiments may be arbitrarily combined, for example, some or all of the steps of different embodiments may be arbitrarily combined, and a certain embodiment may be arbitrarily combined with an optional implementation of other embodiments.

In various embodiments of the present disclosure, unless specified otherwise or there is a logical conflict, terms and/or descriptions among various embodiments are of consistency and may be referenced to each other, and technical features in different embodiments may be combined to form a new embodiment based on their internal logical relationships.

Terms used in embodiments of the present disclosure are for the purpose of describing specific embodiments and are not intended to limit the present disclosure.

In embodiments of the present disclosure, unless specified otherwise, an element expressed in the singular form, such as expressed with words like “a”, “an”, “the”, “described above”, “said”, “aforementioned”, “this”, etc., may mean “one and only one”, or mean “one or more”, “at least one”, etc. For example, a noun after an article like “a”, “an”, “the” in English may be understood as a singular expression or a plural expression.

In embodiments of the present disclosure, “a plurality of” refers to two or more.

In some embodiments, phrases like “at least one of”, “one or more”, “a plurality of”, “multiple”, etc. may be used interchangeably.

In some embodiments, expressions like “at least one of A or B”, “A and/or B”, “A in a case, B in another case”, “A in response to a case, B in response to another case”, etc., may include the following technical solutions depending on situations: A in some embodiments (A is performed independently of B); B in some embodiments (B is performed independently of A); in some embodiments, selection is made from A and B (A and B are selectively performed); both A and B in some embodiments (both A and B are performed). The same applies when there are more branches such as A, B, and C.

In some embodiments, the expression “A or B” may include the following technical solutions depending on situations: in some embodiments, A (A is performed independently of B); in some embodiments, B (B is performed independently of A); in some embodiments, selection is made from A and B (A and B are selectively performed). The same applies when there are more branches such as A, B, and C.

The prefixes such as “first” and “second” in embodiments of the present disclosure are used to distinguish different objects described, and do not constitute restrictions on the position, order, priority, quantity or content of the described objects. The statement for the described objects refers to the description in the context of the claims or embodiments, and the use of prefixes should not bring unnecessary restrictions. For example, if the described objects are “fields”, such as “first field” and “second field”, the ordinal numbers, i.e., “first” and “second”, before these “fields” do not limit positions or order of these “fields”, and the “first” and “second” do not limit whether the “fields” they define are in the same message, nor do they limit the order of the “first field” and the “second field”. For another example, if the described objects are “levels”, such as “first level” and “second level”, the ordinal numbers before these “levels” do not limit the priority between these “levels”. For another example, the number of the described object is not limited by the ordinal number, the number of the described object may be one or more. Taking “first apparatus” as an example, the number of the “apparatus” may be one or more. In addition, the objects defined by different prefixes may be the same or different. For example, if the described object is “apparatus”, then “first apparatus” and “second apparatus” may be the same apparatus or different apparatuses, and their types may be the same or different. For another example, if the described object is “information”, then “first information” and “second information” may be the same information or different information, and their contents may be the same or different.

In some embodiments, “including A”, “comprising A”, “used to indicate A”, and “carrying A” may be interpreted as “directly carrying A” or “indirectly indicating A”.

In some embodiments, phrases such as “in response to . . . ”, “in response to determining . . . ”, “in case of . . . ”, “upon . . . ”, “when . . . ”, “if . . . ”, etc. may be used interchangeably.

In some embodiments, terms such as “greater than”, “greater than or equal to”, “not less than”, “more than”, “more than or equal to”, “not less than”, “higher than”, “higher than or equal to”, “not lower than”, and “above” may be replaced with each other, and terms such as “smaller than”, “smaller than or equal to”, “not greater than”, “less than”, “less than or equal to”, “no more than”, “lower than”, “lower than or equal to”, “not higher than”, and “below” may be replaced with each other.

In some embodiments, apparatuses or the like may be interpreted as physical or virtual, and their names are not limited to those recorded in embodiments. Terms such as “apparatus”, “equipment”, “device”, “circuit”, “network element”, “node”, “function”, “unit”, “section”, “system”, “network”, “chip”, “chip system”, “entity”, and “body” may be used interchangeably.

In some embodiments, terms such as “access network device (AN device)”, “radio access network device (RAN device)”, “base station (BS)”, “radio base station”, “fixed station”, “node”, “access point”, “transmission point (TP)”, “reception point (RP)”, “transmission/reception point (TRP)”, “panel (panel)”, “antenna panel”, “antenna array”, “cell”, “macro cell”, “small cell”, “femto cell”, “pico cell”, “sector”, “cell group”, “serving cell”, “carrier”, “component carrier”, “bandwidth part (BWP)” and the like may be used interchangeably.

In some embodiments, terms such as “terminal”, “terminal device”, “user equipment (UE)”, “user terminal” “mobile station (MS)”, “mobile terminal (MT)”, subscriber station, mobile unit, subscriber unit, wireless unit, remote unit, mobile device, wireless device, wireless communication device, remote device, mobile subscriber station, access terminal, mobile terminal, wireless terminal, remote terminal, handset, user agent, mobile client, client and the like may be used interchangeably.

In some embodiments, an access network device, a core network device, or a network device may be replaced by a terminal. For example, the communication between a terminal and an access network device, a core network device or a network device may be replaced by the communication structure among terminals (may also be referred to as for example device-to-device (D2D), vehicle-to-everything (V2X), etc.), which may also apply various embodiments of the present disclosure. In this case, a structure may be set in which the terminal has all or part of functions of the access network device. In addition, terms such as “uplink” and “downlink” may also be replaced by a term (e.g., “side”) corresponding to the communication among terminals. For example, an uplink channel, a downlink channel, etc. may be replaced by a side channel, and an uplink, a downlink, etc. may be replaced by a sidelink.

In some embodiments, a terminal may be replaced by an access network device, a core network device, or a network device. In this case, a structure may be set in which the access network device, the core network device, or the network device has all or part of functions of the terminal.

In some embodiments, names of information are not limited to those recorded in embodiments, and terms such as “information”, “message”, “signal”, “signaling”, “report”, “configuration”, “indication”, “instruction”, “command”, “channel”, “parameter”, “domain”, “field”, “symbol”, “code element”, “code element”, “codebook”, “codeword”, “codepoint”, “bit”, “data”, “program”, and “chip” may be used interchangeably.

In some embodiments, terms such as “codebook”, “codeword”, “precoding matrix” and the like are interchangeable. For example, a codebook may be a collection of one or more codewords/precoding matrices.

In some embodiments, terms such as “uplink”, “up link”, “physical uplink” are interchangeable, and terms such as “downlink”, “down link”, “physical downlink” are interchangeable, and terms such as “side”, “sidelink”, “side communication”, “sidelink communication”, “direct connection”, “direct link”, “direct communication”, “direct link communication” are interchangeable.

In some embodiments, terms such as “downlink control information (DCI)”, “downlink (DL) assignment”, “DL DCI”′ and the like may be used interchangeably, and terms such as “uplink (UL) grant”, “UL DCI” and the like may be used interchangeably.

In some embodiments, terms such as “physical downlink shared channel (PDSCH)”, “DL data” and the like are interchangeable, and terms such as “physical uplink shared channel (PUSCH)”, “UL data” and the like are interchangeable.

In some embodiments, terms such as “radio”, “wireless”, “radio access network (RAN)”, “access network (AN)”, “RAN-based” and the like may be used interchangeably.

In some embodiments, terms such as “search space”, “search space set”, “search space configuration”, “search space set configuration”, “control resource set (CORESET)”, “CORESET configuration” and the like are interchangeable.

In some embodiments, terms such as “synchronization signal (SS)”, “synchronization signal block (SSB)”, “reference signal (RS)”, “pilot”, and “pilot signal” may be used interchangeably.

In some embodiments, terms such as “moment”, “time point”, “time”, and “time position” are interchangeable, and terms such as “duration”, “period”, “time window”, “window”, and “time” are interchangeable.

In some embodiments, terms such as “component carrier (CC)”, “cell”, “frequency carrier”, “carrier frequency” and the like may be used interchangeably.

In some embodiments, terms such as “resource block (RB)”, “physical resource block (PRB)”, “sub-carrier group (SCG)”, “resource element group (REG)”, “PRB pair”, “RB pair”, and “resource element (RE)” may be used interchangeably.

In some embodiments, terms such as wireless access scheme, waveform, etc. may be used interchangeably.

In some embodiments, terms “precoding”, “precoder”, “weight”, “precoding weight”, “quasi-co-location (QCL)”, “transmission configuration indication (TCI) state”, “spatial relation”, “spatial domain filter”, “transmission power”, “phase rotation”, “antenna port”, “antenna port group”, “layer”, “the number of layers”, “rank”, “resource”, “resource set”, “resource group”, “beam”, “beam width”, “beam angular degree”, “antenna”, “antenna element”, “panel” and the like may be used interchangeably.

In some embodiments, terms such as “frame”, “radio frame”, “subframe”, “slot”, “sub-slot”, “mini-slot”, “symbol”, “code element”, “transmission time interval (TTI)” and so on may be used interchangeably.

In some embodiments, “acquire”, “obtain”, “get”, “reception”, “transmission”, “bidirectional transmission”, “transmission and/or reception” are interchangeable, and may be interpreted as reception from other entities, obtaining from a protocol, acquiring by self-processing, autonomous implementation, etc.

In some embodiments, terms such as “send”, “emit”, “report”, “distribute”, “transmit”, “bidirectional transmission”, “send and/or receive” may be used interchangeably.

In some embodiments, “predetermined” or “preset” may be interpreted as pre-specified in a protocol, etc., or may be interpreted as a pre-set action performed by a device, etc.

In some embodiments, determining may be interpreted as estimating, deciding, judging, calculating, computing, processing, deriving, investigating, retrieving, looking up, searching, inquiring, ascertaining, receiving, transmitting, inputting, outputting, accessing, resolving, selecting, choosing, establishing, comparing, “assuming”, “expecting”, “considering”, broadcasting, notifying, communicating, forwarding, configuring, reconfiguring, allocating, mapping, assigning, etc., but is not limited thereto.

In some embodiments, the determination or judgment may be made by virtue of a value represented by 1 bit (0 or 1), by virtue of a true or false value (Boolean value), or may also be made by comparison of numerical values (for example, comparison with a predetermined value), but is not limited thereto.

In some embodiments, “network” may be interpreted as devices included in the network (e.g., access network device, core network device, etc.).

In some embodiments, “not expecting to receive” may be interpreted as not receiving on a time domain resource and/or frequency domain resource, or may be interpreted as not performing subsequent processing on data or the like after it is received; “not expecting to send” may be interpreted as not sending, or may be interpreted as sending but not expecting the recipient to respond to the sent content.

In some embodiments, acquisition of data, information, etc. may comply with the laws and regulations of the country where the activity takes place.

In some embodiments, data, information, etc. may be obtained with the user's consent.

In addition, each element, each row, or each column in the table of embodiments of the present disclosure may be implemented as an independent embodiment, and the combination of any elements, any rows, and/or any columns may also be implemented as an independent embodiment.

With the continuous development of wireless communications, the requirements for communication capabilities are getting higher and higher. For application scenarios such as augmented reality (AR)/virtual reality (VR), Internet of Vehicles, and Internet of Things, ultra-high-speed, ultra-low-latency, and ultra-large bandwidth communications have become the norm. In order to meet this requirement, more and more new technologies have been proposed.

Terahertz technology is a potential key technology for 6G and is highly likely to be incorporated into 6G standards. Terahertz communication is considered to be an important candidate air interface technology for achieving a communication rate of 6G Tbps/s, and is expected to be used in holographic communication, micro-size communication, ultra-large capacity data backhaul, short-distance ultra-high-speed transmission and other scenarios. At the same time, the high-precision positioning and high-resolution perception imaging of networks and/or terminals by utilizing the ultra-large bandwidth and high-precision resolution of terahertz are the extended application directions of terahertz communication.

In the future, the communication frequency of wireless networks will evolve from sub-6G to millimeter waves, and further to terahertz full-band networking. The covered services are not limited to communication. Perception and positioning will also become one of the important services of future 6G networks. However, the two existing waveforms, i.e., discrete Fourier transform single carrier orthogonal frequency division multiplexing (DFT-SC-OFDM) and cyclic prefix orthogonal frequency division multiplexing (CP-OFDM) waveforms, are difficult to meet other needs beyond communication services. Therefore, discussions are currently underway to introduce more waveforms in 6G networks to adapt to different services, for example, introduction of orthogonal time frequency space (OTFS) waveform in ultra-high-speed mobile scenarios and introduction of frequency modulated continuous wave (FMCW) waveform in perception scenarios, etc., and different waveforms correspond to different advantageous scenarios. Therefore, in a system where multiple waveforms coexist, the problem of determining a transmission waveform for uplink and downlink channels needs to be solved urgently.

To this end, embodiments of the present disclosure propose a waveform determination method and apparatus, and provide technical solutions for determining a transmission waveform for uplink and downlink channels.

Embodiments of a first aspect of the present disclosure provide a waveform determination method, which is performed by a terminal and includes: receiving waveform indication information sent by a network device; and determining working waveform information to be used by the terminal according to the waveform indication information.

In some embodiments of the present disclosure, the method further includes: receiving first waveform information sent by the network device, where the first waveform information is communication waveform information supported by the network device; determining second waveform information according to the first waveform information, where the second waveform information is communication waveform information supportable by the terminal and determined by the terminal according to the first waveform information; and sending the second waveform information to the network device.

In some embodiments of the present disclosure, the second waveform information is a part or all of the first waveform information.

In some embodiments of the present disclosure, before receiving the waveform indication information sent by the network device, the method further includes: receiving candidate waveform set information sent by the network device; determining third waveform information from the candidate waveform set information according to a waveform selection parameter; and sending the third waveform information to the network device.

In some embodiments of the present disclosure, the waveform selection parameter includes at least one of: a service type; a moving speed of the terminal; a distance between the terminal and the network device; or requirement information of peak to average power ratio (PAPR).

In some embodiments of the present disclosure, the candidate waveform set information is a part or all of the second waveform information.

In some embodiments of the present disclosure, determining the working waveform information to be used by the terminal according to the waveform indication information includes: determining, according to the waveform indication information, that the working waveform information to be used by the terminal is the third waveform information. The third waveform information may be recommended waveform information determined by the terminal from the candidate waveform set information according to the waveform selection parameter.

In some embodiments of the present disclosure, the method further includes: updating a communication waveform corresponding to the third waveform information on a corresponding bandwidth resource according to the waveform indication information.

In some embodiments of the present disclosure, determining the working waveform information to be used by the terminal according to the waveform indication information includes: determining, according to the waveform indication information, that the working waveform information to be used by the terminal is fourth waveform information, where the fourth waveform information is communication waveform information in the second waveform information. For example, the fourth waveform information may be designated waveform information sent by the network device according to an actual situation, such as an original communication waveform of the terminal, a waveform specified by a protocol, or other waveform information different from the recommended third waveform information.

In some embodiments of the present disclosure, the waveform indication information is used to instruct the terminal whether to initiate waveform switch.

In some embodiments of the present disclosure, determining the working waveform information to be used by the terminal according to the waveform indication information includes: in response to the waveform indication information indicating not to initiate the waveform switch, determining that the working waveform information to be used by the terminal is original working waveform information or preset waveform information.

In some embodiments of the present disclosure, before receiving the waveform indication information sent by the network device, the method further includes: receiving switching indication information sent by the network device, where the switching indication information is used to instruct the terminal whether to initiate waveform switch.

Embodiments of a second aspect of the present disclosure provide a waveform determination method, which is performed by a network device and includes: sending waveform indication information to a terminal, where the waveform indication information is used for determining working waveform information to be used by a terminal.

In some embodiments of the present disclosure, the method further includes: sending first waveform information to the terminal, where the first waveform information is communication waveform information supported by the network device; and receiving second waveform information sent by the terminal, where the second waveform information is communication waveform information supportable by the terminal and determined by the terminal according to the first waveform information.

In some embodiments of the present disclosure, the second waveform information is a part or all of the first waveform information.

In some embodiments of the present disclosure, before sending the waveform indication information to the terminal, the method further includes: determining candidate waveform set information according to the second waveform information; and sending the candidate waveform set information to the terminal.

In some embodiments of the present disclosure, the candidate waveform set information is a part or all of the second waveform information.

In some embodiments of the present disclosure, the method further includes: receiving third waveform information sent by the terminal, where the third waveform information is communication waveform information determined by the terminal from the candidate waveform set information according to a waveform selection parameter.

In some embodiments of the present disclosure, the waveform selection parameter includes at least one of: a service type; a moving speed of the terminal; a distance between the terminal and the network device; or requirement information of PAPR.

In some embodiments of the present disclosure, sending the waveform indication information to the terminal includes: sending the waveform indication information to the terminal according to the third waveform information.

In some embodiments of the present disclosure, the waveform indication information is sent via one of: a radio resource control (RRC) signaling; a media access control control element (MAC CE) signaling; or a downlink control information (DCI) signaling.

In some embodiments of the present disclosure, the waveform indication information indicates whether to initiate waveform switch.

In some embodiments of the present disclosure, the first waveform information is sent via one of: a physical broadcast channel (PBCH); a primary synchronization signal (PSS); or a secondary synchronization signal (SSS).

In some embodiments of the present disclosure, before sending the waveform indication information to the terminal, the method further includes: sending switching indication information to the terminal, where the switching indication information is used to instruct the terminal whether to initiate waveform switch.

Embodiments of a third aspect of the present disclosure provide a waveform determination apparatus, which is applied to a terminal, and includes: a first communication module, configured to receive waveform indication information sent by a network device; and a determination module, configured to determine working waveform information to be used by the terminal according to the waveform indication information.

Embodiments of a fourth aspect of the present disclosure provide a waveform determination apparatus, which is applied to a network device, includes: a second communication module, configured to send waveform indication information to a terminal, where the waveform indication information is used for determining working waveform information to be used by a terminal.

Embodiments of a fifth aspect of the present disclosure provide a communication system, which includes: a terminal, configured to perform the method as described in embodiments of the first aspect; and a network device, configured to perform the method as described in embodiments of the second aspect.

Embodiments of a sixth aspect of the present disclosure provide a communication device, which includes: a transceiver; a memory; and a processor. The processor is connected to the transceiver and the memory respectively, and configured to execute computer-executable instructions on the memory to control wireless signal transmission and reception of the transceiver and implement the method as described in embodiments of the first aspect or the method as described in embodiments of the second aspect.

Embodiments of a seventh aspect of the present disclosure provide a non-transitory computer storage medium having stored therein computer-executable instructions that, when executed by a processor, cause the method as described in embodiments of the first aspect or the method as described in embodiments of the second aspect to be implemented.

Embodiments of the present disclosure provide a waveform determination method and apparatus, and provide technical solutions for determining the transmission waveform for uplink and downlink channels. Specifically, the terminal may receive the waveform indication information sent by the network device; and determine the working waveform information to be used by the terminal according to the waveform indication information. By applying the technical solutions of embodiments of the present disclosure, the transmission between transmitting and receiving ends may be flexibly changed to adapt to changes in service types and channels.

The waveform determination method and apparatus provided by the present disclosure are described in detail below with reference to the accompanying drawings.

FIG. 1 shows a structural diagram of a communication system according to embodiments of the present disclosure. As shown in FIG. 1, the system architecture may include a terminal 11 and a network device 12.

In some examples, the terminal 11 may be called a terminal device, a user equipment, a mobile station (MS), a mobile terminal (MT), etc. The terminal 11 may also be a car with a communication function, a smart car, a mobile phone, a wearable device, a Pad, a computer with wireless transceiver function, a virtual reality device, an augmented reality device, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. Embodiments of the present disclosure do not limit the specific technology and device form adopted by the terminal 11.

In some examples, the network device 12 may be an entity at the network side for transmitting or receiving signals. For example, the network device 12 may be an evolved NodeB (eNB), a transmission reception point (TRP), a next generation NodeB (gNB) in an NR system, a base station in other future mobile communication systems, or an access node in a wireless networking (Wi-Fi™) system. Embodiments of the present disclosure do not limit the specific technology and device form adopted by the network device 12. The network device 12 provided in embodiments of the present disclosure may be composed of a central unit (CU) and a distributed unit (DU), where the CU may also be referred to as a control unit. The CU-DU structure allows to split protocol layers of the network device, such as a base station, functions of some protocol layers are set in the CU for centralized control, functions of some or all of the remaining protocol layers are distributed in DUs, and the DUs are centrally controlled by the CU.

It may be understood that the communication system described in embodiments of the present disclosure is for the purpose of more clearly illustrating the technical solutions of embodiments of the present disclosure, and does not constitute a limitation on the technical solutions proposed in embodiments of the present disclosure. A person of ordinary skill in the art may know that with the evolution of the system architecture and the emergence of new service scenarios, the technical solutions proposed in embodiments of the present disclosure are also applicable to similar technical problems.

The following embodiments of the present disclosure may be applied to the communication system or a part of subjects shown in FIG. 1, but are not limited thereto. The subjects shown in FIG. 1 are examples, and the communication system may include all or part of the subjects in FIG. 1, or may include other subjects not shown in FIG. 1, and the number and form of the subjects are arbitrary, and the connection relationship among the subjects is an example, and these subjects may be connected or disconnected with each other, and the connection may be in any manner, either a direct connection or an indirect connection, or either a wired connection or a wireless connection.

Various embodiments of the present disclosure may be applied to Long Term Evolution (LTE), LTE-Advanced (LTE-A), LTE-Beyond (LTE-B), SUPER 3G, IMT-Advanced, 4th generation mobile communication system (4G), 5th generation mobile communication system (5G), 5G new radio (NR), Future Radio Access (FRA), New Radio Access Technology (RAT), New Radio (NR), New radio access (NX), Future generation radio access (FX), Global System for Mobile communications (GSM (registered trademark)), CDMA2000, Ultra Mobile Broadband (UMB), IEEE 802.11 (Wi-Fi (registered trademark)), IEEE 802.16 (WiMAX (registered trademark)), IEEE 802.20, Ultra-WideBand (UWB), Bluetooth (registered trademark), Public Land Mobile Network (PLMN) network, Device-to-Device (D2D) system, Machine-to-Machine (M2M) system, Internet of Things (IOT) system, Vehicle-to-Everything (V2X), systems using other communication methods, next-generation systems expanded based thereon, etc. In addition, multiple systems may also be combined (for example, a combination of LTE or LTE-A and 5G) for application.

In some examples, the network device 12 may send waveform indication information to the terminal 11; the terminal 11 receives the waveform indication information sent by the network device 12; and the working waveform information used by the terminal 11 is determined according to the waveform indication information. The working waveform information used by the terminal 11 may be determined by the network device 12.

Embodiments of the present disclosure provide technical solutions for determining a transmission waveform for uplink and downlink channels. By applying the technical solutions of embodiments of the present disclosure, the transmission between transmitting and receiving ends may be flexibly changed to adapt to changes in service types and channels.

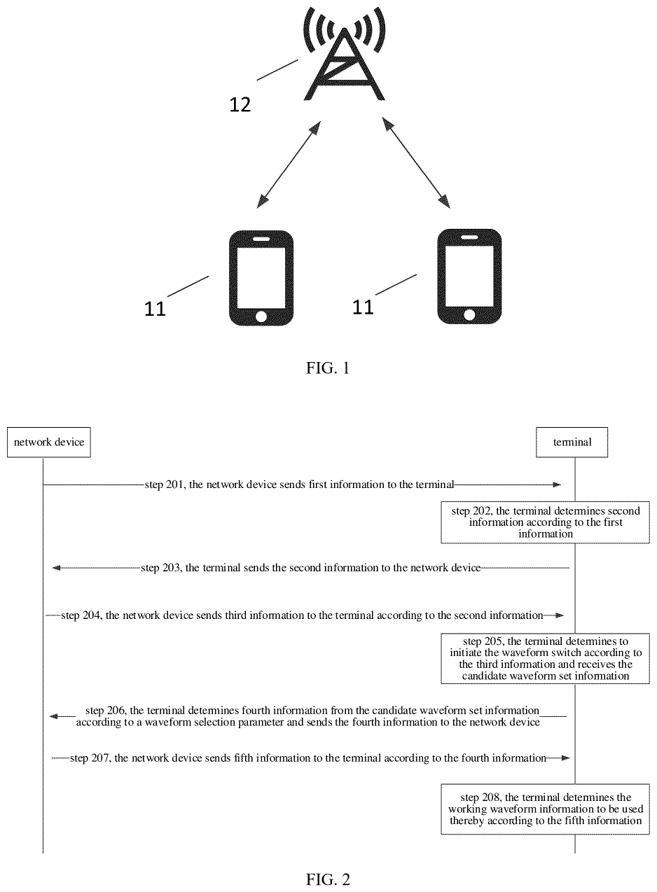

Further, in order to illustrate specific execution process of the above communication system, FIG. 2 shows a schematic timing diagram of a waveform determination method according to embodiments of the present disclosure. The method is applied to the communication system, and as shown in FIG. 2, may include the following steps.

In step 201, a network device sends first information to a terminal.

In some embodiments, the terminal receives the first information.

In some embodiments, the first information may be used to indicate which communication waveform is supported by the network device. For example, the first information may be a kind of indication information, or may be referred to as first waveform information, which is used to indicate the communication waveform supported by the network device.

For example, the first information may indicate that the network device supports three communication waveforms A, B, and C, or it may indicate that the network device does not support waveform D (for example, there are a total of four communication waveforms A, B, C, and D, if the network device does not support waveform D, it may indirectly indicate that the network device supports the other three communication waveforms). In short, the first information may reflect the ability of the network device to support waveforms.

In some embodiments, the first information may be sent via one of: PBCH; PSS; or SSS.

In step 202, the terminal determines second information according to the first information.

In some embodiments, the second information is determined by the terminal according to the communication waveform supported by the network device and indicates which communication waveform is supportable by the terminal. For example, the second information may be referred to as second waveform information, which may be communication waveform information supportable by the terminal and determined by the terminal according to the first waveform information, i.e., waveform support capability information of the terminal, and such information may include a waveform identifier, such as a waveform index, for describing the waveform that is supportable by the terminal for communication transmission. The waveform index may be specified by a protocol.

For example, the network device supports three communication waveforms A, B, and C, and the terminal itself supports two communication waveforms A and B. The terminal calculates an intersection of the two communication waveform sets to obtain two communication waveforms A and B, and then determines and obtains the second waveform information. Alternatively, the terminal supports more waveforms, for example, three waveforms A, B, and D, and the terminal knows that the network device supports three waveforms A, B, and C, then the terminal obtains an intersection of the waveforms supported by the network device and the waveforms supported by itself to determine the second waveform information indicating that the terminal supports two waveforms A and B. Of course, it should be understood that the terminal may also determine the second information without relying on the first information, that is, the terminal may directly determine the second information. In other words, the terminal may directly determine the second information based on its own capabilities. For example, the network device supports three communication waveforms A, B, and C, and may inform its waveform support capability to the terminal through the first information. However, the terminal does not perform a set operation on the waveforms supported by itself and the waveforms supported by the network device, but directly determines the waveform information supported by itself, and subsequently informs the network device for the network device to perform waveform selection.

In step 203, the terminal sends the second information to the network device.

In some embodiments, after the terminal determines the second information, the terminal may send the determined second information to the network device to inform the network device of the waveform support capability of the terminal. For example, the terminal may inform the network device of which waveform it supports, or which waveform it does not support, and accordingly, the network device may learn the waveform support capability of the terminal according to the second information sent by the terminal.

In summary, the network device and the terminal may exchange waveform support capability information, and inform their own waveform support capabilities to each other through the first information and the second information respectively.

In step 204, the network device sends third information to the terminal according to the second information.

In some embodiments, the third information may be used to indicate whether the terminal may initiate waveform switch, and the third information may be referred to as switching indication information or waveform indication information, etc., which is not limited. For example, the network device determines, according to the waveform support capability of the terminal, whether the terminal's communication waveform switch will cause interference to the communication of other terminals in the same serving cell, based on which the network device determines whether to instruct the terminal to perform waveform switch and indicates the network device's determination result to the terminal via the third information. In a case where the network device determines that the terminal's communication waveform switch will not cause interference to the communication of other terminals in the same serving cell, it determines that the terminal may initiate the waveform switch; accordingly, the network device may send the third information, and the terminal may determine according to the third information that it may initiate the waveform switch. Conversely, in a case where the network device determines that the terminal's communication waveform switch will cause interference to the communication of other terminals in the same serving cell, it determines that the terminal should not initiate waveform switch, accordingly, the network device may send the third information to the terminal to inform the terminal device not to initiate the waveform switch.

In some embodiments, the third information may be implicit, for example, the third information may include candidate waveform set information. When the terminal receives the third information including the candidate waveform set information, the terminal may determine that the terminal may initiate waveform switch, that is, the terminal may select a communication waveform from the candidate waveform set information as a new communication waveform to implement the waveform switch, but the selected new communication waveform needs to be approved by the network device before it is used. For example, in a case where the network device determines that the terminal may initiate the waveform switch, the network device will send the candidate waveform set information to the terminal. The candidate waveform set information is determined according to the second waveform information (corresponding to the second information). For example, one or more waveforms that will not cause interference to the communication of other terminals are further selected from the waveforms supported by the terminal and combined to obtain the candidate waveform set information, and the candidate waveform set information is sent to the terminal.

In some embodiments, the candidate waveform set information may be included in the third information. Alternatively, the network device may send the third information and the candidate waveform set information separately, and the third information is indication information that the terminal may initiate the waveform switch.

In some embodiments, the third information may be sent via one of: an RRC signaling; an MAC CE signaling; a DCI signaling; or a Physical Random Access Channel (PRACH) channel.

In some embodiments, the third information may also be explicit. For example, a bit in the MAC CE signaling is used to indicate whether the terminal may initiate the waveform switch, for example, “1” indicates that the terminal may initiate the waveform switch, and “0” indicates that the terminal cannot initiate the waveform switch; or “0” indicates that the terminal may initiate the waveform switch, and “1” indicates that the terminal cannot initiate the waveform switch, etc.

In some embodiments, the network device determines that the terminal may initiate the waveform switch, and sends the third information to the terminal to instruct the terminal to initiate the waveform switch, and at the same time, the network device informs the terminal of the candidate waveform set information. The terminal receives the candidate waveform set information and may perform at least some of steps 205 to 208. In some embodiments, the network device determines that the terminal should not initiate the waveform switch, and sends the third information to the terminal to instruct the terminal not to initiate the waveform switch, and after receiving the third information sent by the network device, the terminal may use the existing working waveform or a protocol-specified waveform to continue communication.

In some embodiments, in addition to information indicating whether the terminal is allowed to initiate the waveform switch, the third information may also include information indicating working waveform information to be used by the terminal. For example, indication information for initiating the waveform switch is sent along with the information indicating a new communication waveform to be switched to. The terminal may switch to the new communication waveform for communication based on the indication information.

In step 205, the terminal determines to initiate the waveform switch according to the third information and receives the candidate waveform set information.

In some embodiments, in the case where the terminal determines to initiate the waveform switch, the terminal may obtain the candidate waveform set information from the third information, or may receive the third information and the candidate waveform set information separately sent by the network device.

In step 206, the terminal determines fourth information from the candidate waveform set information according to a waveform selection parameter and sends the fourth information to the network device.

In some embodiments, the fourth information may be used to determine a communication waveform that the terminal expects to use, i.e., recommended waveform information, which may be called third waveform information. The terminal sends the third waveform information to the network device, in the hope that the network device will approve its use of the third waveform information as the working waveform information.

The waveform selection parameter is used to determine the third waveform information, i.e., the recommended waveform information. The waveform selection parameter may be pre-acquired by the terminal, or may be acquired in real time according to immediate needs. In some examples, the waveform selection parameter includes at least one of: a service type (such as communication, perception, positioning, etc.); a moving speed of the terminal; a distance between the terminal and the network device; or requirement information of PAPR.

The terminal may determine the third waveform information from the candidate waveform set information according to the above waveform selection parameter and a corresponding rule. For example, in a case where the terminal moves at a high speed, the Doppler frequency shift is relatively large, so the OTFS waveform may be used to introduce a Doppler domain to reduce related interference; in a case where the terminal moves at a low speed, the CP-OFDM waveform may be used; in a case where the terminal is far away from the network device, the DFT-SC-OFDM waveform may be used; in a case where the terminal is close to the network device, the CP-OFDM waveform may be used, etc.

In some embodiments, the network device may not send the indication information to the terminal on whether the waveform switch may be initiated, and may directly send the candidate waveform set information, that is, the third information is the candidate waveform set information. The terminal selects a recommended waveform from the candidate waveform set based on the candidate waveform set information and the waveform selection parameter, and sends it to the network device, in the hope that the network device will approve its use of the recommended waveform information as the working waveform information.

In step 207, the network device sends fifth information to the terminal according to the fourth information.

In some embodiments, the fifth information may be waveform indication information, which is used to indicate to the terminal the working waveform information used by the terminal.

In some embodiments, the fifth information may be indication information of approving or disapproving the terminal's use of the third waveform information. For example, the network device may send such indication information in the form of approval or disapproval, or send indication information of using the third waveform information (informing the terminal that its use of the third waveform information is approved, or send indication information of continuing using the original waveform information or the specified waveform information (informing the terminal that its use of the third waveform information is disapproved).

In some embodiments, the fifth information may also be fourth waveform information, and the fourth waveform information is communication waveform information in the above-mentioned second waveform information (communication waveform information supported by the terminal). For example, the fourth waveform information may be a specified waveform information sent by the network device depending on situations, such as the original communication waveform of the terminal, the waveform specified by the protocol, or other waveform information different from the recommended third waveform information.

In some embodiments, the fifth information may be sent via one of: an RRC signaling; a MAC CE signaling; or a DCI signaling.

In step 208, the terminal determines the working waveform information to be used thereby according to the fifth information.

For example, the terminal recommends the third waveform information to the network device, the network device approves of the terminal's use of the third waveform information for communication, and the network device sends a corresponding waveform indication information to indicate that the terminal may use the third waveform information for communication. If the terminal receives a feedback from the network device that the network device approves of using the third waveform information to update the waveform, the communication waveform is updated on a corresponding bandwidth resource according to the indication of the network device. If the terminal receives a feedback from the network device that the network device disapproves of using the third waveform information to update the waveform, the existing working waveform or the waveform specified by the protocol may be used to continue the communication.

In some embodiments of the present disclosure, the terminal and the network device described may be the terminal 11 and the network device 12 in the aforementioned embodiments.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

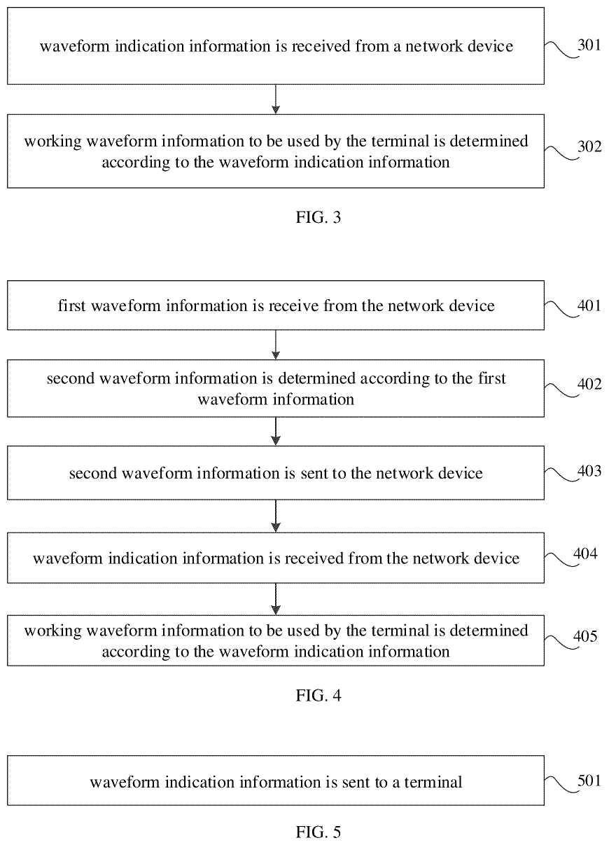

To illustrate a specific execution process of the terminal, FIG. 3 shows a schematic flow chart of a waveform determination method according to embodiments of the present disclosure. The method is applied to the terminal side, and may include the following steps.

In step 301, waveform indication information is received from a network device.

In step 302, working waveform information to be used by the terminal is determined according to the waveform indication information.

In embodiments of the present disclosure, the network device may determine the working waveform information to be used by the terminal and indicate the working waveform information through the sent waveform indication information. The terminal communicates according to the working waveform information indicated by the network device. In some examples, the network device may instruct the terminal to use the original working waveform, the waveform specified by the protocol, or switch to a new working waveform for communication. For example, the working waveform may be one of a DFT-SC-OFDM waveform, a CP-OFDM waveform, an OTFS waveform or an FMCW waveform.

In some embodiments of the present disclosure, the terminal and the network device described may be the terminal 11 and the network device 12 in the aforementioned embodiments.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

FIG. 4 shows a schematic flow chart of a waveform determination method according to embodiments of the present disclosure. Based on embodiments shown in FIG. 3, as shown in FIG. 4, the method is applied to the terminal side and may include the following steps.

In step 401, first waveform information is receive from the network device.

The first waveform information may be communication waveform information supported by the network device. In embodiments of the present disclosure, waveform capabilities of the network device and the terminal need to be aligned first. The network device will send the waveform information it supports, namely the first waveform information, to the terminal.

In step 402, second waveform information is determined according to the first waveform information.

The second waveform information may be communication waveform information supportable by the terminal and determined by the terminal according to the first waveform information, i.e., waveform support capability information of the terminal, and such information may include a waveform identifier, such as a waveform index, for describing the waveform that is supportable by the terminal for communication transmission. The waveform index may be specified by a protocol.

In embodiments of the present disclosure, the waveform information supported by the terminal itself may be less than the first waveform information (the waveform information supported by the network device), or may be equal to the first waveform information, or may be more than the first waveform information. The terminal may determine the second waveform information from the first waveform information according to the waveform information supported by itself, and the second waveform information may be waveform information supported by both the terminal and the network device. In some examples, the second waveform information may be all or part of the first waveform information, that is, the second waveform information is information on all or part of waveforms selected from a waveform set supported by the network device, which may be determined depending on situations.

In step 403, second waveform information is sent to the network device.

The terminal may send the second waveform information to the network device to inform the network device of the waveform information supported by the terminal. The waveform information is also supported by the network device, thereby completing the waveform capability alignment between the network device and the terminal.

In step 404, waveform indication information is received from the network device.

In some examples, before step 404, the method of embodiments of the present disclosure may further include: receiving candidate waveform set information sent by the network device; determining third waveform information from the candidate waveform set information according to a waveform selection parameter; and sending the third waveform information to the network device. The third waveform information may include a waveform identifier, such as a waveform index, for describing a waveform recommended by the terminal.

The third waveform information may be recommended waveform information sent by the terminal to the network device in consideration of an application scenario, that is, the terminal requests the network device whether the terminal may use the recommended waveform information as its working waveform information. The network device may determine whether the terminal may use the recommended waveform information depending on the situation of the current network, such as whether the communication of other terminals in the same serving cell will be interfered when the terminal uses the recommended waveform information, and then send the corresponding waveform indication information.

The waveform selection parameter is used to determine the third waveform information, i.e., the recommended waveform information. In some examples, the waveform selection parameter includes at least one of: a service type; a moving speed of the terminal; a distance between the terminal and the network device; or requirement information of PAPR.

The terminal may determine the third waveform information from the candidate waveform set information according to the above waveform selection parameter and a corresponding rule.

In some examples, the candidate waveform set information may be all or part of the second waveform information. The second waveform information is waveform set information that is supported and reported by the terminal. The network device will consider actual situations, for example whether the communication of other terminals in the same serving cell will be interfered when the terminal uses a certain waveform in this waveform set information for communication, and then perform waveform selection from the second waveform information according to the degree of such influence to obtain the candidate waveform set information.

In step 405, working waveform information to be used by the terminal is determined according to the waveform indication information.

In some examples, the step 405 may include: determining, according to the waveform indication information, that the working waveform information to be used by the terminal is the third waveform information. For example, the terminal recommends the third waveform information to the network device, and the network device approves of the terminal's use of the third waveform information for communication, and the network device sends a corresponding waveform indication information to indicate that the terminal may use the third waveform information for communication.

Further, in the case where the network device approves of the terminal's use of the third waveform information for communication, in some examples, the method according to embodiments of the present disclosure may further include: updating a communication waveform corresponding to the third waveform information on a corresponding bandwidth resource according to the waveform indication information. For example, in a case where the terminal receives a feedback from the network device that the network device approves of using the third waveform information to update the waveform, the communication waveform is updated on a corresponding bandwidth resource according to the indication of the network device.

In some examples, the step 405 may include: determining, according to the waveform indication information, that the working waveform information to be used by the terminal is fourth waveform information, and the fourth waveform information is communication waveform information in the second waveform information.

For example, the network device receives the third waveform information sent by the terminal, and does not approve of the terminal's use of the third waveform information taken into account the interference to other terminals. In this case, the terminal will receive information in which the network device does not feed back approval of using the third waveform information to update the waveform, and keep the original communication waveform unchanged.

For another example, the network device may also send waveform indication information to the terminal depending on situations, to instruct the terminal to use specified waveform information as the working waveform information for communication, and the specified waveform information may be one of the second waveform information supported by the terminal. The specified waveform information may be the original communication waveform of the terminal, or the waveform specified by the protocol, or other waveform information different from the recommended third waveform information, etc.

In some examples, the waveform indication information may be used to instruct the terminal whether to initiate waveform switch. Accordingly, the step 405 may include: in response to the waveform indication information indicating not to initiate the waveform switch, determining that the working waveform information to be used by the terminal is original working waveform information or preset waveform information. In a case where the waveform indication information indicates that the terminal may initiate the waveform switch, the terminal may subsequently receive the waveform indication information indicating the working waveform information from the network device.

In some examples, before the step 404, the method may also include: receiving switching indication information sent by the network device, and the switching indication information is used to instruct the terminal whether to initiate the waveform switch.

For example, after the terminal sends the second waveform information to the network device, the network device will determine whether the terminal should initiate the waveform switch depending on situations, such as depending on whether the waveform switch of the terminal will cause interference to the communications of other terminals, and send a corresponding switching indication information. The terminal may determine whether to initiate the waveform switch according to the switching indication information. If it is determined to initiate the waveform switch, the terminal will subsequently receive the waveform indication information indicating the working waveform information from the network device; if it is determined not to initiate the waveform switch, the existing working waveform or the protocol-specified waveform will be used to continue the communication, etc.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

Further, in order to illustrate a specific execution process of the network device, FIG. 5 shows a schematic flow chart of a waveform determination method according to embodiments of the present disclosure. The method is applied to the network device side and may include the following steps.

In step 501, waveform indication information is sent to a terminal.

The waveform indication information may be used to determine working waveform information to be used by the terminal. For this embodiment, the network device may determine the working waveform information to be used by the terminal and indicate the working waveform information through the waveform indication information sent. For example, the working waveform may be one of a DFT-SC-OFDM waveform, a CP-OFDM waveform, an OTFS waveform or an FMCW waveform.

Regarding the description of specific examples for embodiments here, reference may be made to the corresponding description of embodiments described with reference to FIG. 1 to FIG. 4, which will not be repeated here.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

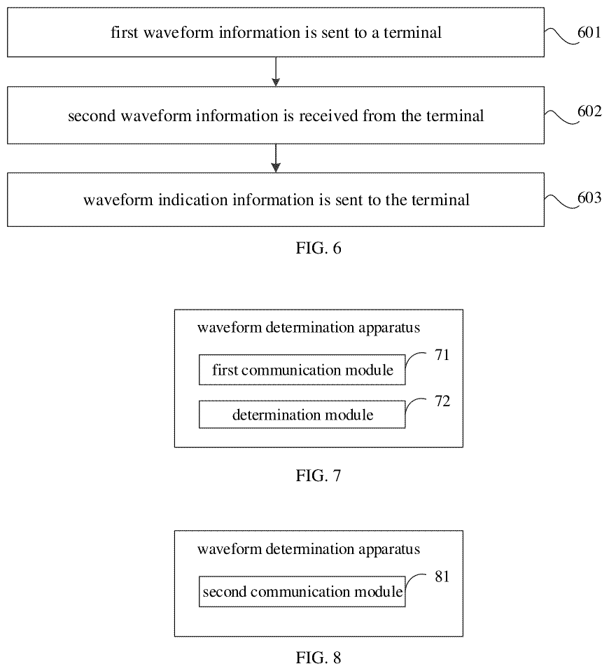

FIG. 6 shows a schematic flow chart of a waveform determination method according to embodiments of the present disclosure. The method is applied to the network device and may include the following steps.

In step 601: first waveform information is sent to a terminal.

The first waveform information is communication waveform information supported by the network device. In embodiments of the present disclosure, capabilities of the network device and the terminal need to be aligned first. The network device will send the waveform information it supports, namely the first waveform information, to the terminal.

In some examples, the first waveform information may be sent via one of: PBCH; PSS; or SSS.

In step 602, second waveform information is received from the terminal.

The second waveform information may be communication waveform information supportable by the terminal and determined by the terminal according to the first waveform information, that is, waveform support capability information of the terminal, such information may include a waveform identifier, such as a waveform index, for describing the waveform that is supportable by the terminal for communication transmission. The waveform index may be specified by a protocol.

In some examples, the second waveform information is all or part of the first waveform information, that is, the second waveform information is information on all or part of waveforms selected from a waveform set supported by the network device, which may be determined depending on situations.

In step 603, waveform indication information is sent to the terminal.

The waveform indication information is used to determine the working waveform information to be used by the terminal.

In some examples, before the step 603, the method according to embodiments of the present disclosure may further include: determining candidate waveform set information according to the second waveform information; and sending the candidate waveform set information to the terminal. Optionally, the candidate waveform set information may be all or part of the second waveform information.

In some examples, before the step 603, the method according to embodiments of the present disclosure may further include: receiving third waveform information sent by the network device, and the third waveform information is communication waveform information determined by the terminal from the candidate waveform set information according to a waveform selection parameter. Accordingly, the step 603 may include: determining the working waveform information to be used by the terminal according to the third waveform information, such as approval or disapproval of the third waveform information.

The waveform selection parameter is used to determine the third waveform information, i.e., recommended waveform information. In some examples, the waveform selection parameter includes at least one of: a service type; a moving speed of the terminal; a distance between the terminal and the network device; or requirement information of PAPR.

The terminal may determine the third waveform information from the candidate waveform set information according to the above waveform selection parameter and a corresponding rule.

In some examples, the step 603 may include: sending waveform indication information to the terminal according to the third waveform information. For example, the terminal recommends the third waveform information to the network device, and if the network device approves of the terminal's use of the third waveform information for communication, the network device will send corresponding waveform indication information to indicate that the terminal may use the third waveform information for communication.

In some examples, the waveform indication information may be sent via one of: an RRC signaling; a MAC CE signaling; or a DCI signaling.

In some examples, the waveform indication information sent in the step 603 may be used to instruct the terminal whether to initiate waveform switch. If the terminal is instructed to initiate the waveform switch, the waveform indication information indicating the working waveform information may be sent to the terminal later.

In some examples, before the step 603, the method according to embodiments of the present disclosure may further include: sending switching indication information to the terminal, and the switching indication information is used to instruct the terminal whether to initiate the waveform switch.

Regarding the description of specific examples for embodiments here, reference may be made to the corresponding description of embodiments described with reference to FIG. 1 to FIG. 5, which will not be repeated here.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

In the above embodiments provided in the present disclosure, the methods according to embodiments of the present disclosure are introduced from perspectives of the network device and the terminal, respectively. In order to implement the various functions in the methods according to the above embodiments of the present disclosure, the network device and the terminal each may include hardware structure and a software module, and implement the above various functions in a form of the hardware structure, the software module, or the hardware structure in combination with the software module. A certain function among the above various functions may be implemented in the manner of the hardware structure, the software module, or the hardware structure in combination with the software module.

Corresponding to the waveform determination methods according to the above embodiments, the present disclosure also provides waveform determination apparatuses. Since the waveform determination apparatuses provided in embodiments of the present disclosure correspond to the waveform determination methods according to the above embodiments, the implementations of the waveform determination methods are also applicable to the waveform determination apparatuses provided in embodiments of the present disclosure and will not be described in detail again.

FIG. 7 is a schematic block diagram of a waveform determination apparatus according to embodiments of the present disclosure, and the waveform determination apparatus may be applied to a terminal.

As shown in FIG. 7, the apparatus may include: a first communication module 71 configured to receive waveform indication information sent by a network device; and a determination module 72 configured to determine the working waveform information to be used by the terminal according to the waveform indication information.

In some embodiments, the first communication module 71 is further configured to receive first waveform information sent by the network device, and the first waveform information is communication waveform information supported by the network device. The determination module 72 is further configured to determine second waveform information according to the first waveform information, and the second waveform information is communication waveform information supportable by the terminal and determined by the terminal according to the first waveform information. The first communication module 71 is further configured to send the second waveform information to the network device.

In some embodiments, the second waveform information is a part or all of the first waveform information.

In some embodiments, the first communication module 71 is further configured to receive candidate waveform set information sent by the network device. The determination module 72 is further configured to determine third waveform information from the candidate waveform set information according to a waveform selection parameter. The first communication module 71 is further configured to send the third waveform information to the network device.

In some embodiments, the waveform selection parameter includes at least one of: a service type; a moving speed of the terminal; a distance between the terminal and the network device; or requirement information of PAPR.

In some embodiments, the candidate waveform set information is a part or all of the second waveform information.

In some embodiments, the determination module 72 is configured to determine, according to the waveform indication information, that the working waveform information to be used by the terminal is the third waveform information.

In some embodiments, the determination module 72 is further configured to update a communication waveform corresponding to the third waveform information on a corresponding bandwidth resource according to the waveform indication information.

In some embodiments, the determination module 72 is configured to determine, according to the waveform indication information, that the working waveform information to be used by the terminal is fourth waveform information, and the fourth waveform information is communication waveform information in the second waveform information.

In some embodiments, the waveform indication information is used to instruct the terminal whether to initiate waveform switch.

In some embodiments, the determination module 72 is configured to: in response to the waveform indication information indicating not to initiate the waveform switch, determine that the working waveform information to be used by the terminal is original working waveform information or preset waveform information.

In some embodiments, the first communication module 71 is further configured to receive switching indication information sent by the network device, and the switching indication information is used to instruct the terminal whether to initiate waveform switch.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

FIG. 8 is a schematic block diagram of a waveform determination apparatus according to embodiments of the present disclosure, and the waveform determination apparatus may be applied to a network device side.

As shown in FIG. 8, the apparatus may include: a second communication module 81 configured to send waveform indication information to a terminal.

In some embodiments, the second communication module 81 is further configured to: send first waveform information to the terminal, where he first waveform information is communication waveform information supported by the network device; and receive second waveform information sent by the terminal, where the second waveform information is communication waveform information supportable by the terminal and determined by the terminal according to the first waveform information.

In some embodiments, the second waveform information is a part or all of the first waveform information.

In some embodiments, the second communication module 81 is further configured to: determine candidate waveform set information according to the second waveform information; and send the candidate waveform set information to the terminal.

In some embodiments, the candidate waveform set information is a part or all of the second waveform information.

In some embodiments, the second communication module 81 is further configured to receive third waveform information sent by the network device, and the third waveform information is communication waveform information determined by the terminal from the candidate waveform set information according to a waveform selection parameter.

In some embodiments, the waveform selection parameter includes at least one of: a service type; a moving speed of the terminal; a distance between the terminal and the network device; or requirement information of PAPR.

In some embodiments, the second communication module 81 is configured to send the waveform indication information to the terminal according to the third waveform information.

In some embodiments, the waveform indication information is sent via one of: an RRC signaling; a (MAC CE signaling; or a DCI signaling.

In some embodiments, the waveform indication information is used to instruct the terminal whether to initiate waveform switch.

In some embodiments, the second communication module 81 is further configured to send switching indication information to the terminal, and the switching indication information is used to instruct the terminal whether to initiate waveform switch.

Embodiments of the present disclosure provide technical solutions for determining the transmission waveform for uplink and downlink channels. By applying the technical solutions as described in embodiments of the present disclosure, the transmission between the transmitting and receiving ends may be flexibly changed to adapt to changes in service types and channels.

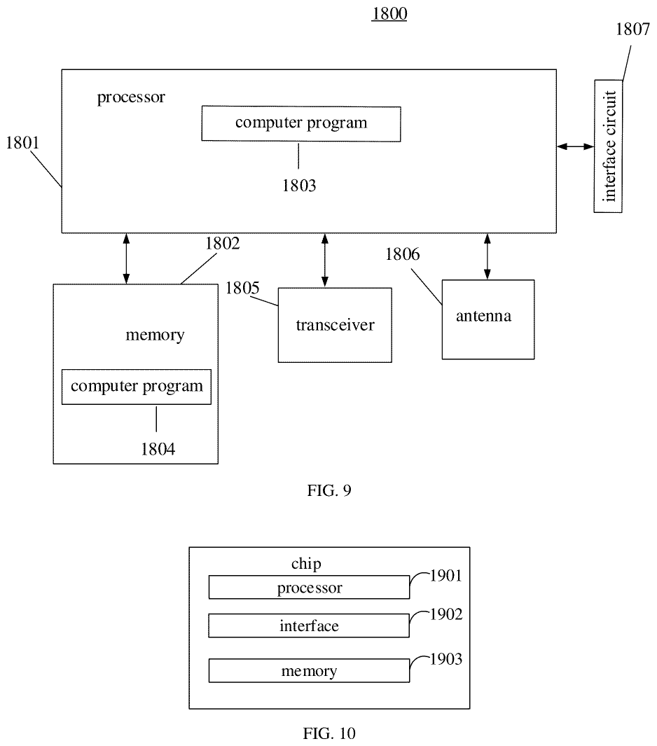

Referring to FIG. 9, FIG. 9 is a schematic block diagram of a communication device 1800 according to embodiments of the present disclosure. The communication device 1800 may be a network device, may also be a user equipment, may also be a chip, a chip system, or a processor that supports the network device to implement the above method, or may also be a chip, a chip system, or a processor that supports the user equipment to implement the above method. The device may be used to implement the methods as described in the above method embodiments, and for details, reference may be made to the descriptions on the above method embodiments.

The communication device 1800 may include one or more processors 1801. The processor 1801 may be a general-purpose processor or a special-purpose processor. For example, it may be a baseband processor or a central processing unit. The baseband processor may be configured to process a communication protocol and communication data, and the central processing unit may be configured to control the communication device (such as a base station, a baseband chip, a terminal, a terminal chip, a DU or a CU, etc.), execute computer programs, and process data of computer programs.

Optionally, the communication device 1800 may further include one or more memories 1802 that may have stored therein a computer program 1804. The processor 1801 executes the computer program 1804 to cause the communication device 1800 to implement the methods as described in the above method embodiments. Optionally, the memory 1802 may have stored therein data. The communication device 1800 and the memory 1802 may be set separately or integrated together.

Optionally, the communication device 1800 may further include a transceiver 1805 and an antenna 1806. The transceiver 1805 may be called a transceiver element, a transceiver machine, a transceiver circuit or the like, for implementing a transceiver function. The transceiver 1805 may include a receiver and a transmitter. The receiver may be called a receiving machine, a receiving circuit or the like, for implementing a receiving function. The transmitter may be called a sending machine, a sending circuit or the like for implementing a sending function.

Optionally, the communication device 1800 may further include one or more interface circuits 1807. The interface circuit 1807 is configured to receive a code instruction and transmit the code instruction to the processor 1801. The processor 1801 runs the code instruction to enable the communication device 1800 to execute the methods as described in the foregoing method embodiments.

In an embodiment, the processor 1801 may include the transceiver configured to implement receiving and sending functions. For example, the transceiver may be a transceiver circuit, an interface, or an interface circuit. The transceiver circuit, the interface or the interface circuit configured to implement the receiving and sending functions may be separated or may be integrated together. The above transceiver circuit, interface or interface circuit may be configured to read and write codes/data, or the above transceiver circuit, interface or interface circuit may be configured to transmit or transfer signals.

In an embodiment, the processor 1801 may have stored therein a computer program 1803 that, when run on the processor 1801, causes the communication device 1800 to implement the method as described in the foregoing method embodiments. The computer program 1803 may be solidified in the processor 1801, and in this case, the processor 1801 may be implemented by hardware.

In an embodiment, the communication device 1800 may include a circuit, and the circuit may implement the sending, receiving or communicating function in the foregoing method embodiments. The processor and the transceiver described in the present disclosure may be implemented on an integrated circuit (IC), an analog IC, a radio frequency integrated circuit (RFIC), a mixed-signal IC, an application specific integrated circuit (ASIC), a printed circuit board (PCB), an electronic device, etc. The processor and the transceiver may also be manufactured using various IC process technologies, such as a complementary metal oxide semiconductor (CMOS), an nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication device described in the above embodiments may be the network device or the user equipment, but the scope of the communication device described in the present disclosure is not limited thereto, and a structure of the communication device is not limited by FIG. 9. The communication device may be a stand-alone device or may be a part of a larger device. For example, the communication device may be:
(1) a stand-alone integrated circuit (IC), or a chip, or a chip system or a subsystem;
(2) a set of one or more ICs, optionally, the set of ICs may also include a storage component for storing data and computer programs;
(3) an ASIC, such as a modem;
(4) a module that may be embedded in other devices;
(5) a receiver, a terminal, an intelligent terminal, a cellular phone, a wireless device, a handheld machine, a mobile unit, a vehicle-mounted device, a network device, a cloud device, an artificial intelligence device, etc. ;
(6) others.

For the case where the communication device may be a chip or a chip system, reference may be made to a schematic structural diagram of the chip shown in FIG. 10. The chip shown in FIG. 10 includes a processor 1901 and an interface 1902, where one or more processors 1901 may be provided, and more than one interface 1902 may be provided.

Optionally, the chip further includes a memory 1903 for storing necessary computer programs and data.

Those skilled in the art may also understand that various illustrative logical blocks and steps listed in embodiments of the present disclosure may be implemented by electronic hardware, computer software, or a combination thereof. Whether such functions are implemented by hardware or software depends on specific applications and design requirements of an overall system. For each specific application, those skilled in the art may use various methods to implement the described functions, but such implementation should not be understood as beyond the protection scope of embodiments of the present disclosure.

The present disclosure also provides a readable storage medium having stored therein instructions that, when executed by a computer, cause functions of any of the above method embodiments to be implemented.

The present disclosure also provides a computer program product that, when executed by a computer, causes functions of any of the above method embodiments to be implemented.

The above embodiments may be implemented in whole or in part by software, hardware, firmware or any combination thereof. When implemented using the software, the above embodiments may be implemented in whole or in part in a form of the computer program product. The computer program product includes one or more computer programs. When the computer program is loaded and executed on the computer, all or part of the processes or functions according to embodiments of the present disclosure will be generated. The computer may be a general purpose computer, a special purpose computer, a computer network, or other programmable devices. The computer program may be stored in a computer-readable storage medium or transmitted from one computer-readable storage medium to another computer-readable storage medium. For example, the computer program may be transmitted from one website site, computer, server or data center to another website site, computer, server or data center in a wired manner (such as via a coaxial cable, an optical fiber, a digital subscriber line (DSL)) or a wireless manner (such as via infrared, wireless, or microwave, etc.). The computer-readable storage medium may be any available medium that can be accessed by the computer, or a data storage device such as a server or a data center integrated by one or more available media. The available medium may be a magnetic medium (for example, a floppy disk, a hard disk, or a magnetic tape), an optical medium (for example, a high-density digital video disc (DVD)), or a semiconductor medium (for example, a solid state disk (SSD)) etc.

Those of ordinary skill in the art can understand that the first, second, and other numeral numbers involved in the present disclosure are for convenience of description, and are not intended to limit the scope of embodiments of the present disclosure, nor are they intended to represent a sequential order.

The term “at least one” used in the present disclosure may also be described as one or more, and the term “a plurality of” may cover two, three, four or more, which are not limited in the present disclosure. In embodiments of the present disclosure, for a certain kind of technical features, the technical features in this kind of technical features are distinguished by terms like “first”, “second”, “third”, “A”, “B”, “C” and “D”, etc., and these technical features described with the “first”, “second”, “third”, “A”, “B”, “C” and “D” have no order of priority and have no order of size.

As used herein, the terms “machine-readable medium” and “computer-readable medium” refer to any computer program product, apparatus, and/or device (e.g., magnetic disk, optical disk, memory, programmable logic device (PLD)) for providing machine instructions and/or data to a programmable processor, including a machine-readable medium that receives machine instructions as machine-readable signals. The term “machine-readable signal” refers to any signal for providing machine instruction and/or data to a programmable processor.

The systems and techniques described herein may be implemented in a computing system including a back-end component (e.g., as a data server), a computing system including a middleware component (e.g., an application server), a computing system including a front-end component (e.g., a user computer with a graphical user interface or a web browser through which a user can interact with implementations of the systems and techniques described herein), or a computing system including any combination of such back-end component, middleware component, or front-end component. The components of the system may be interconnected by any form or medium of digital data communication (e.g., a communication network). Examples of the communication network include: a local area network (LAN), a wide area network (WAN), and the Internet.

A computer system may include a client and a server. The client and server are generally remote from each other and usually interact through a communication network. The client-server relationship is generated by computer programs that run on respective computers and have a client-server relationship with each other.

It should be understood that the various forms of processes shown above may be used, with steps reordered, added, or deleted. For example, the steps described in the present disclosure may be executed in parallel, sequentially, or in different orders, as long as the desired result of the technical solution of the present disclosure can be achieved, which is not limited by the present disclosure.

Further, it should be understood that the various embodiments described in the present disclosure may be implemented independently or in combination with other embodiments as permitted by the scheme.

Those of ordinary skill in the art can appreciate that the units and algorithm steps of various examples described in conjunction with embodiments disclosed herein may be implemented by the electronic hardware, or a combination of the computer software and the electronic hardware. Whether these functions are executed by the hardware or the software depends on the specific applications and design constraints of the technical solution. For each particular application, those skilled in the art may use different methods to implement the described functions, but such implementation should not be considered beyond the scope of the present disclosure.

Those skilled in the art can clearly understand that for the convenience and brevity of the description, the specific working process of the above-described system, apparatus and unit may refer to the corresponding process in the foregoing method embodiments, which will not be repeated here.

The above describes some embodiments of the present disclosure, but the protection scope of the present disclosure is not limited thereto. Any changes or substitutions that are conceivable to those skilled in the art within the technical scope of the present disclosure should fall within the protection scope of the present disclosure. Therefore, the protection scope of the present disclosure should be determined by the protection scope of the claims.

1. A waveform determination method, performed by a terminal, comprising:
receiving waveform indication information sent by a network device; and
determining working waveform information to be used by the terminal according to the waveform indication information.

2. The method according to claim 1, further comprising:
receiving first waveform information sent by the network device, wherein the first waveform information is communication waveform information supported by the network device;
determining second waveform information according to the first waveform information, wherein the second waveform information is communication waveform information supportable by the terminal and determined by the terminal according to the first waveform information; and
sending the second waveform information to the network device.

3. (canceled)

4. The method according to claim 2, wherein before receiving the waveform indication information sent by the network device, the method further comprises:
receiving candidate waveform set information sent by the network device;
determining third waveform information from the candidate waveform set information according to a waveform selection parameter; and
sending the third waveform information to the network device.

5. The method according to claim 4, wherein the waveform selection parameter comprises at least one of:
a service type;
a moving speed of the terminal;
a distance between the terminal and the network device; or
requirement information of peak to average power ratio (PAPR).

6. (canceled)

7. The method according to claim 4, wherein determining the working waveform information to be used by the terminal according to the waveform indication information comprises:
determining, according to the waveform indication information, that the working waveform information to be used by the terminal is the third waveform information.

8. The method according to claim 7, further comprising:
updating a communication waveform corresponding to the third waveform information on a corresponding bandwidth resource according to the waveform indication information.

9. The method according to claim 2, or wherein determining the working waveform information to be used by the terminal according to the waveform indication information comprises:
determining, according to the waveform indication information, that the working waveform information to be used by the terminal is fourth waveform information, wherein the fourth waveform information is communication waveform information in the second waveform information.

10. The method according to claim 2, or wherein the waveform indication information is used to instruct the terminal whether to initiate waveform switch.

11. The method according to claim 10, wherein determining the working waveform information to be used by the terminal according to the waveform indication information comprises:
in response to the waveform indication information indicating not to initiate the waveform switch, determining that the working waveform information to be used by the terminal is original working waveform information or preset waveform information.

12. The method according to claim wherein before receiving the waveform indication information sent by the network device, the method further comprises:
receiving switching indication information sent by the network device, wherein the switching indication information is used to instruct the terminal whether to initiate waveform switch.

13. A waveform determination method, performed by a network device, comprising:
sending waveform indication information to a terminal, wherein the waveform indication information is used for determining working waveform information to be used by a terminal.

14. The method according to claim 13, further comprising:
sending first waveform information to the terminal, wherein the first waveform information is communication waveform information supported by the network device; and
receiving second waveform information sent by the terminal, wherein the second waveform information is communication waveform information supportable by the terminal and determined by the terminal according to the first waveform information.

15. (canceled)

16. The method according to claim 14, wherein before sending the waveform indication information to the terminal, the method further comprises:
determining candidate waveform set information according to the second waveform information; and
sending the candidate waveform set information to the terminal.

17. (canceled)

18. The method according to claim 16, wherein before sending the waveform indication information to the terminal, the method further comprises:
receiving third waveform information sent by the terminal, wherein the third waveform information is communication waveform information determined by the terminal from the candidate waveform set information according to a waveform selection parameter.

19. The method according to claim 18, wherein the waveform selection parameter comprises at least one of:
a service type;
a moving speed of the terminal;
a distance between the terminal and the network device; or
requirement information of peak to average power ratio (PAPR).

20. The method according to claim 19, wherein sending the waveform indication information to the terminal comprises:
sending the waveform indication information to the terminal according to the third waveform information.

21. (canceled)

22. (canceled)

23. The method according to claim 13, wherein the waveform indication information is used to instruct the terminal whether to initiate waveform switch.

24. The method according to claim 13, wherein before sending the waveform indication information to the terminal, the method further comprises:
sending switching indication information to the terminal, wherein the switching indication information is used to instruct the terminal whether to initiate waveform switch.

25.-27. (canceled)

28. A communication device, comprising:
a transceiver;
a memory; and
a processor, connected to the transceiver and the memory respectively, configured to implement the method according to claim 1.

29. (canceled)

30. A communication device, comprising:
a transceiver;
a memory; and
a processor, connected to the transceiver and the memory respectively, configured to implement the method according to claim 13.
